(19) United States
(12) Patent Application Publication
(10) Pub. No.: US 2007/0063393 A1
(43) Pub. Date: Mar. 22, 2007

(54) VACUUM ASSISTED RESIN TRANSFER MOLDING TECHNIQUES WITH FLOW FLOODING CHAMBER

(76) Inventors: Nicolas Vernin, Riom (FR); Mourad Chohra, Epernon (FR); Suresh Advani, Newark, DE (US); Justin Alms, Hockessin, DE (US)

Correspondence Address: CONNOLLY BOVE LODGE & HUTZ, LLP, P O BOX 2207, WILMINGTON, DE, 19899, US

(21) Appl. No.: 11/458,122

(22) Filed: Jul. 18, 2006

Related U.S. Application Data
(60) Provisional application No. 60/719,508, filed on Sep. 22, 2005.

(51) Int. Cl. B29C 70/00

(52) U.S. Cl. 264/511; 264/571; 425/504

(57) ABSTRACT

Vacuum assisted resin transfer molding techniques are improved by mounting a rigid external shell on top of a vacuum bag. The shell is sealed around the vacuum bag so that a vacuum is created between the shell and the vacuum bag, the vacuum causes the vacuum bag to be freely stretched and lifted away from the preform to create a flow flooding chamber which provides a flow channel on the top face of the preform to accelerate the resin flow and reduce the injection time.

### CROSS REFERENCE TO RELATED APPLICATION

This application is based on provisional application Ser. No. 60/719,508, filed Sep. 22, 2005.

### GOVERNMENT LICENSE RIGHTS

The United States government has rights in this invention which was done under funding by Office of Naval Research under Grant N00014-03-1-0891.

### BACKGROUND OF INVENTION

This invention relates to the resin delivery in a composite manufacturing process called Vacuum Assisted Resin Transfer Molding (VARTM).

VARTM is a subclass of Liquid Composite Molding process, which is a method to deliver the resin to cover and saturate the fiber preform and subsequently cure the resin. One must saturate the preform before it begins curing as after the resin starts to cure the viscosity of the resin increases preventing any further impregnation.

VARTM is commonly used to manufacture polymer composite parts due to its simplicity, ability to yield near-net-shaped parts, and low equipment and tooling costs. In VARTM, a preform is placed on a tool surface and covered with a flexible bag. A vacuum is drawn which seals the preform with the bag and resin is drawn into the preform. The resin impregnates the preform due to the pressure gradient. Once the resin reaches the vent, the injection is discontinued but the vacuum is maintained until the resin cures.

The delivery of the resin can be improved by using a flow enhancement layer or distribution media which is used to cover the preform during the injection process. The effect of the distribution media is to decrease filling time and improve the resin delivery but its use is not always feasible or can result in a superfluous permanent feature in the final composite part. Also in order to separate the distribution media from the part a peel ply is placed between the distribution media and the preform. After the part cures, the distribution media along with the peel ply are peeled away from the part and thrown away which causes addition waste and cost. On the other hand, if no distribution media is used, the injection times can be an order of magnitude larger to fill the part definitely increasing the possibility of the resin to cure during infusion. Neither of these options is particularly ideal.

### SUMMARY OF INVENTION

An object of this invention is to provide a solution which circumvents the need for a distribution media to achieve low injection times. Thus the desired composite part can be created with injection times that are comparable to when one uses a distribution media but as our process does not use the distribution media there is no wasted material in terms of distribution media and peel ply and in addition there is time and labor savings as one does not have to manually place the peel ply and distribution media on top of the preform and remove it after the part has cured. There is also saving in the resin quantity used as most of the resin that goes into the distribution media and the peel ply is wasted.

In accordance with this invention a flow channel is placed on the top face of the fabric preform creating a Flow Flooding Chamber (FFC) to accelerate the resin flow and reduce the injection time. To accomplish this, we locally lift the bag using a rigid, external vacuum chamber, which is placed on top of the bag during injection.

### THE DRAWINGS

FIG. 1 is a schematic showing of a VARTM unit in accordance with this invention;

FIG. 2 illustrates the resin movement in the Flow Flooding Chamber (FFC) in a VARTM unit in accordance with this invention;

FIGS. 3-9 illustrate various steps in the practice of this invention; and

FIGS. 10-13 illustrate variations of VARTM units in accordance with this invention.

### DETAILED DESCRIPTION

This application is based upon provisional application Ser. No. 60/719,508, filed Sep. 22, 2005, all of the details of which are incorporated herein by reference thereto.

The present invention is directed to replacing the conventional distribution media and associated peel ply in VARTM. This results in the cost advantages related to omitting the distribution media such as shipping, storage and non-cycleable trash. Moreover, the distribution media can not always be used because, for example, particles in resin suspension can not penetrate the peel ply and the distribution media must become a permanent feature of the finished part or not be used at all.

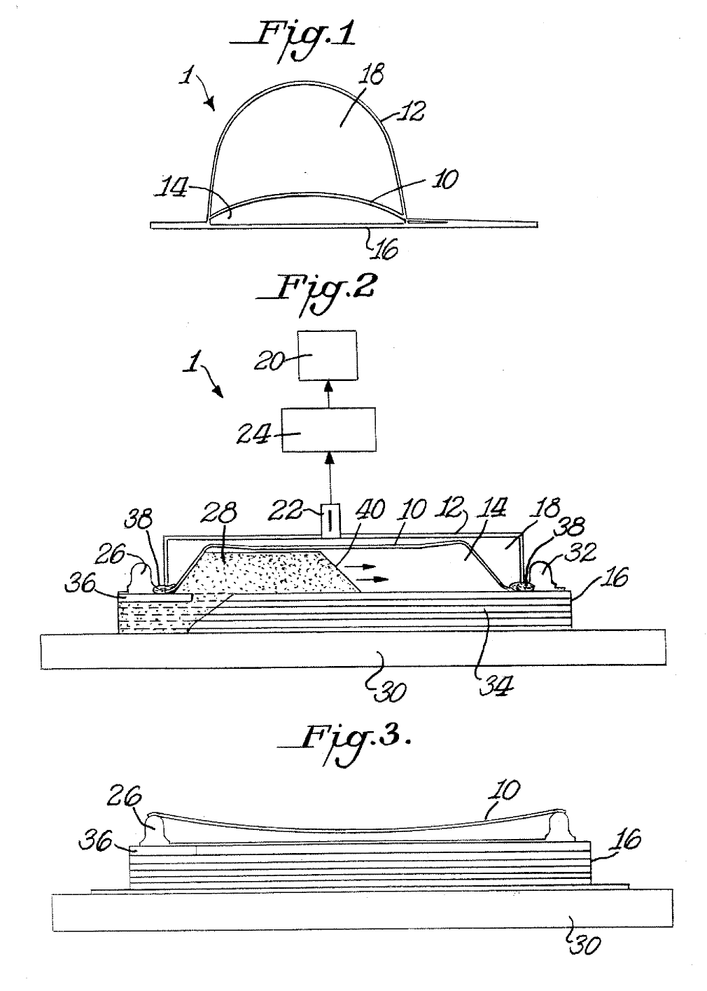

The basic concept of this invention, as illustrated in FIG. 1, is to create a flow channel on the top face of the fabric 16 to accelerate the resin flow and reduce the injection time. As illustrated in FIG. 1 this is accomplished in unit 1 by locally lifting the vacuum bag 10 through the use of a rigid external vacuum chamber between bag 10 and shell 12 which is placed on top of the bag during injection thereby creating a Flow Flooding Chamber (FFC) 14. As illustrated in FIG. 1 the vacuum bag 10 is mounted over preform 16. The FFC is created by the vacuum in chamber 18 in the space between shell 12 and vacuum bag 10 causing vacuum bag 10 to stretch outwardly thereby creating the FFC 14. FIG. 1 schematically exemplifies the general principles of this invention. In that regard, the shell 12, for example, may be of any suitable size and shape. What is important is that the vacuum created below the shell and above the vacuum bag 10 causes the vacuum bag 10 to stretch away from the fabric or preform 16 so as to create the flow flooding chamber wherein the resin flow is accelerated and the injection time is reduced.

FIG. 2 illustrates in greater detail a practice of this invention. As shown in FIG. 2 the vacuum chamber 18 is created by placing a rigid, preferably air impermeable shell 12 over and sealed around the vacuum bag 10. As illustrated in FIG. 2 a vacuum is created in chamber 18 through use of a vacuum pump 20 which communicates with vacuum hose or line 22 through pressure regulator 24. Although FIG. 2 illustrates only one vacuum hose any suitable number, such as two or three hoses or even more could be used. The vacuum created in chamber 18 lifts the bagging film 10 away from preform 16 which creates the FFC 14. FIG. 2 illustrates the details of the vacuum assisted resin transfer molding unit 1 to include an injection line 26 for the resin 28 with the arrows in FFC 14 showing direction of the flow front 40 of the resin 28 above the preform 16 on support surface 30. The downstream vacuum line 32 is also illustrated downstream from the flow front 40. The preform 16 would have low permeability as indicated by the reference numeral 34. A high permeability channel 36 is also shown, as well as the super high permeability being in the FFC 14. Chamber 18 functions as a flow improvement channel.

A particular advantage of the unit 1 shown in FIG. 2 which is preferably used in all practices of this invention is the inclusion of the pressure regulator 24 which could be of any known construction. Pressure regulator 24 permits a changing or precise controlling of the amount of vacuum created in flow improvement chamber 18 thereby controlling the stretching of vacuum bag 10 which marks a distinct improvement over prior systems. Vacuum bag 10 is thus able to freely stretch in the sense that it is not forced into any channels or other structure, but rather stretches in response to the vacuum and the distance of stretching, in turn, is controlled by pressure regulator 24. By being able to control the distance or height of degree of stretching of bag 10 uniform pressure and optimization can be achieved in applying the resin to the preform. This results in pressure being released acting on the fabric preform 16. In addition, the effective permeability under the chamber is raised and a channel 14 for resin flow is created.

The chamber or shell 12 with, for example, a flexible rubber seal 38 is placed on top of the vacuum bag 10. The vacuum in the chamber 18 is applied which lifts the vacuum bag 10 away from the top surface of the fabric 16. As the bag 10 lifts and stretches it
increases the effective permeability of the preform 16 beneath the chamber 18, by lifting the vacuum bag and creating a gap 14 between the preform 16 and the bag 10,
the gap 14 serves as a high permeability channel (FFC) between the bag 10 and the preform 16 through which the resin flow is enhanced and the resin can flow virtually unimpeded.

Then as soon as the vacuum in the chamber 18 is released, the atmospheric pressure compresses the vacuum bag 10 on the fabrics so that the resin 28 is driven down through the thickness direction of the fabric or composite 16. After the infusion is completed, the Flow Flooding Chamber 14 is removed allowing the excess resin to collapse, thus improving the quality of the composite.

As composite parts are usually only about ⅛ inch in thickness and can be a few feet in length and width direction, the specific characteristic of this process is to flood one of the faces of the composite 16 by accelerating the flow in between the bag 10 and the fabric along the top face. FIG. 2 illustrates this process.

The introduction of a Flow Flooding Chamber (FFC) provides the following improvements.

Waste Reduction

The general motivation for this method was to investigate the Vacuum Assisted Resin Transfer Molding (VARTM) composite manufacturing process to find ways to reduce waste products with the goal of optimizing injection times. More specifically, the intent was to replace the distribution media and the associated peel ply in the VARTM process and thereby eliminate all of its associated costs and drawbacks.

The Manufacturing Improvement

The use of a user controlled chamber such as the FFC can improve the flexibility of the VARTM process. Indeed, the FFC setup allows for good control of the flow during the time of the infusion, whereas the distribution media is fixed at the beginning of the VARTM process and cannot be moved or controlled. The availability of flow control with FFC will allow one to perform infusion in complex parts such as parts with inserts, by resorting to flow control. Potential to control the flow will also allow one to accept more variability in process and materials during manufacturing as the use of short pot life resin systems and short cycle time.

There is a decrease in filling time.

With FFC, a significant reduction of race-tracking effect along the chamber during the infusion was also observed. The race-tracking is defined as the resin flow will follow the path of least resistance, and in this case, because there was a constant gap between the fabrics and the stretched bag, the flow front stays straight during injection.

Improved Quality

FFC also helps improve the quality of the part. The excess resin on the top surface or preform 16 created by the chamber results in a very smooth surface finish that is desirable in many sports and transportation industries for instance. This is a significant improvement compared to the rough surfaces that characterize the VARTM process due to the peeling of the peel ply from the top surface of the composite and also the surface quality obtainable with VARTM process may be affected at high vacuum levels by the distribution media print-through.

There is only one current process which has some similarities to the FFC method of resin delivery. That process is called FAST Remotely Actuated Channels (FASTRAC). FASTRAC is a process where a metal plate has channels milled on one side and placed on top of a VARTM set up. Then a second VARTM bag is sealed around the metal plate and vacuumed. This type of a process is called a “double bagging” process. The bag between the preform and the metal plate is stretched into the channels which creates channels of high permeability. Accordingly, with FASTRAC there is controlled stretching of the bag (i.e. directed into the channels), in contrast to the bag being freely stretched with the FFC method.

Though the FASTRAC method has some similarities, the goals and ultimately the results differ dramatically. The goal of the FASTRAC method is to simply speed up the resin flow along small channels, where in the FFC method, the principal goal is to put all the needed resin for complete saturation of the preform inside the chamber, then to apply atmosphere pressure. The fundamental differences between the two processes lead to the advantages of the FFC method of resin delivery. FFC is advantageous to FASTRAC primarily because the milled metal plate must be net shaped. The tooling and labor cost of such a set up would offset the main advantage of using VARTM. FEC only requires an arbitrarily shaped part that can be made of cheap materials with no additional machining.

Other advantages of the FFC process include in-line flow control, less waste, and versatility. The FFC works mainly on the principal of the stretching of the VARTM bag due to a pressure difference. With the use of a vacuum regulator this important pressure difference can be accurately controlled. Specifying the pressure difference is a control mechanism for the amount of stretching that will occur. With such ability, the resin flow can be changed during the infusion of a composite part, which is unavailable in the FASTRAC process. Since the FFC is not a “double bagging” process, there is a reduction of waste materials between FASTRAC and FFC. The control advantages lead to the extreme versatility of the process to create composite parts with liquid composite molding on any size scale.

The FFC chamber's system has been designed to improve the manufacturing of composite parts by reducing the filling time, increase the flexibility of VARTM and reducing the waste and labor. This process can also be integrated in a procedure for the injection of complex parts or parts with inserts for minimum fill times.

The FFC chamber illustrated is for flat composite parts, but is adaptive to more complicated shapes as stairs and curvatures, which have applications in many different industries. The size of the part is not a limit because the FFC chamber can be adaptive to any flat shape.

The use of the FFC chamber results in the creation of a high permeability region in which the resin flows. The consequence is that an excess of resin occurs on top of the preform lay up. Such an excess resin results in a significant decrease of the fiber volume fraction and the mechanical properties of the final composite part can consequently be affected. This disadvantage can, however, be overcome. Indeed, once vacuum is released in the chamber, atmospheric pressure is applied on the top of the bag, which is not enough to push the excess resin out of the VARTM setup. To address this issue, a higher pressure value, or positive pressure, can be applied in the chamber at the end of the infusion to allow the excess resin to flow out of the lay up into the vent line. High fibers volume fraction can then be obtained. However for applications in which higher fiber volume fractions are not needed, one can see this as an advantage as the good surface finish is a natural outcome of this process.

The invention may be practiced with numerous variations. For example, the resistance of the preform can be bypassed preceding the FFC chamber (90° rotation of the chamber to keep it closer to the injection line). The flow rate in the chamber can be increased by plugging it on a highly permeable region. The filling can be accomplished in the width direction by moving the chamber laterally once the length of the chamber is filled with resin. The result of this would be to infuse this kind of flat panel in a composite as fast as with a distribution media.

In a variation the Flow Flooding Chamber is enlarged to correspond to the width of the part.

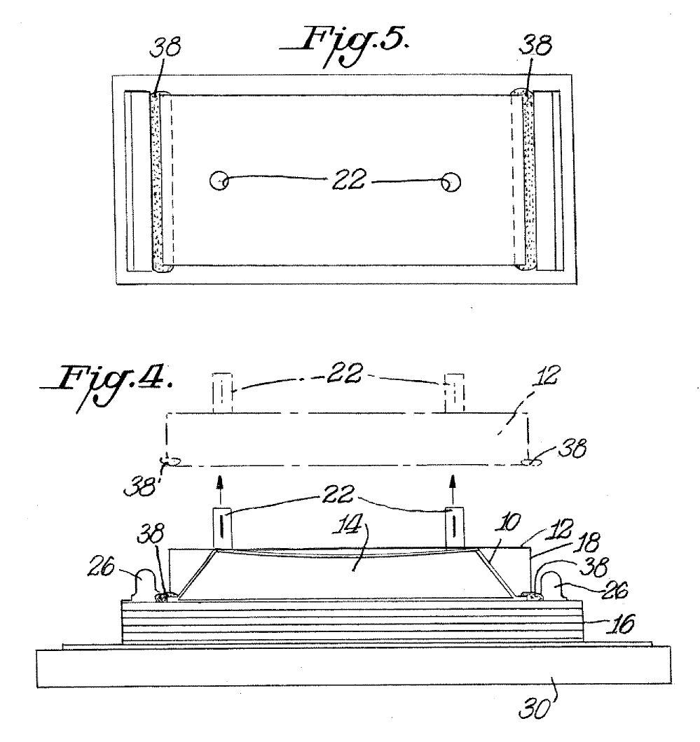

FIGS. 3-9 illustrate the sequence in various steps in practicing the invention. As shown therein the first step would be VARTM set-up illustrated in FIG. 3. In the embodiment shown in FIG. 3, the preform 16 is in the form of E-Glass fibers, The vacuum below bag 10 sucks the bag 10 down resulting in compaction of the fibers. FIG. 3 also illustrates the high permeability region 36.

FIGS. 4-5 illustrate in side and top views the chamber set up where a rigid shell 12 is mounted over the vacuum bag 10. When vacuum is applied to vacuum tubes 22, 22 the flow improvement chamber 18 causes bag 10 to freely stretch away from the top surface of preform 16 thereby creating the FFC 14.

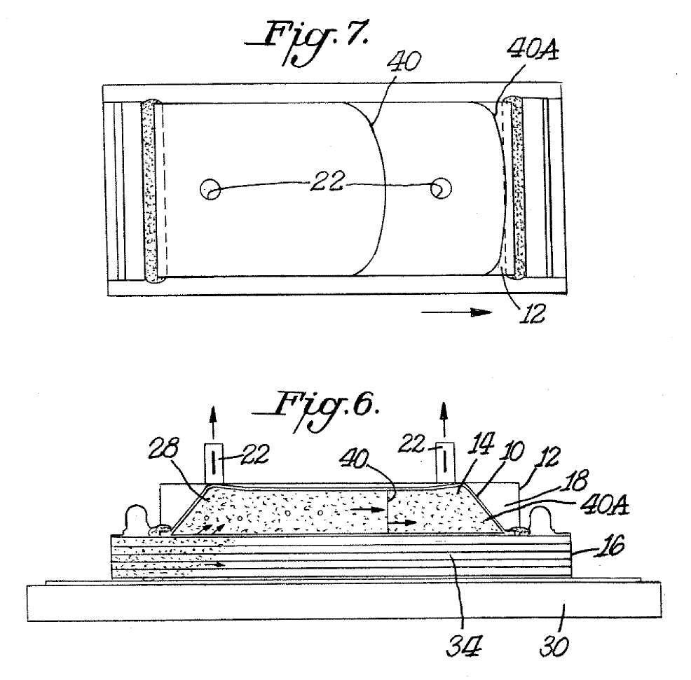

FIGS. 6-7 show in side and top views the resin injection while a vacuum is created above the vacuum bag 10. In this embodiment the chamber is 10 inches by 15 inches and the chamber filling time is 40 minutes, 30 seconds. As shown in FIGS. 6-7 the resin 28 runs in high permeability channels in FFC 14 with the resin flow front indicated by the reference numeral 40. The fibers of preform 16 have low permeability 34 while the FFC 14 has high permeability. Ultimately, the resin 28 would flow completely downstream to the end of bag 10 at the flow front 40A.

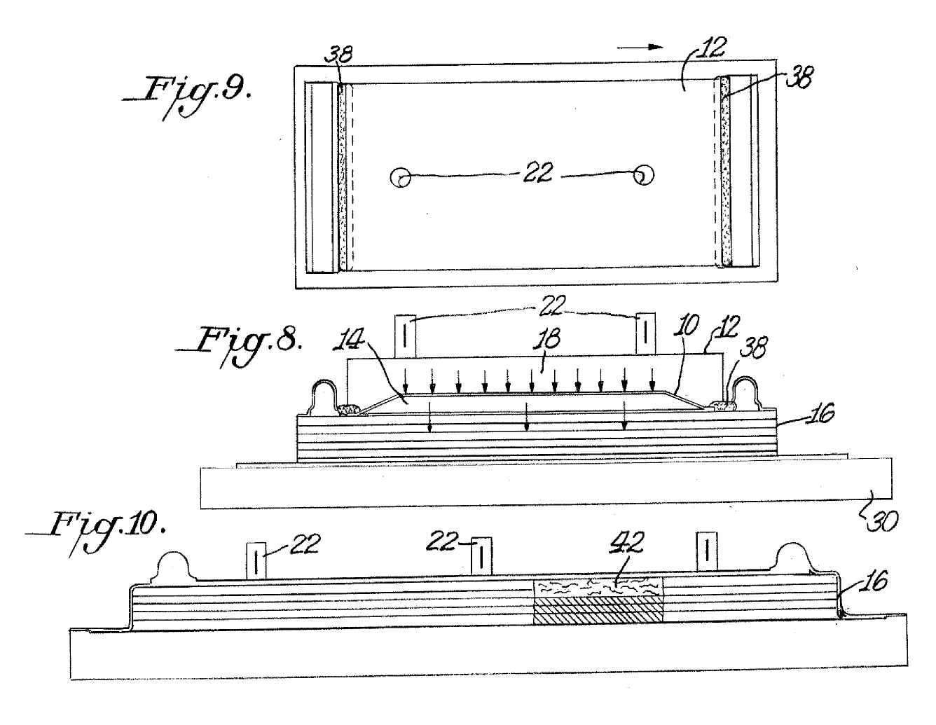

FIGS. 8-9 illustrate in side and top views the atmospheric pressure affects when the vacuum is released in the chamber 18 and removed from the chamber. The positive pressure in chamber 18 compresses bag 10 on the fabric 16 so that the resin is driven down through the thickness direction of the fabric 16. After infusion is completed the FFC 14 is removed allowing the excess resin to collapse.

The present invention could be practiced with many variations in accordance with the desired results. One such form of variations includes the use of inserts either above and/or below the vacuum bag 10 for such purposes as increasing the flexibility of the FFC and splitting the FFC into small chambers. Such inserts could be of any suitable size, shape or material. One form of insert could be a flat rectangular plate which could be rigid or compressible. The size of the chambers 14 and 18 could also vary. In one practice of the invention the unit could have a chamber large enough to cover all of the preform.

FIG. 10 also shows a variation of the invention wherein the flexibility of the Flow Flooding Chamber is increased. As illustrated therein this is accomplished through the use of one or more inserts 42.

FIG. 10 illustrates a unit which includes an insert 42 made, for example, of rubber in the area to the right of the center vacuum tube 22. With the unit of FIG. 10 which includes at least three vacuum tubes 22 the whole top face of the preform 16 is filled very quickly. When the vacuum is released (as in FIG. 8) the resin is driven down through the thickness direction of the composite preform 16. In the unit of FIG. 10 a flat panel composite 16 could be infused as fast as with a distribution media and without any peel ply. This unit results in a very good surface finish and the possibility to infuse panels with inserts.

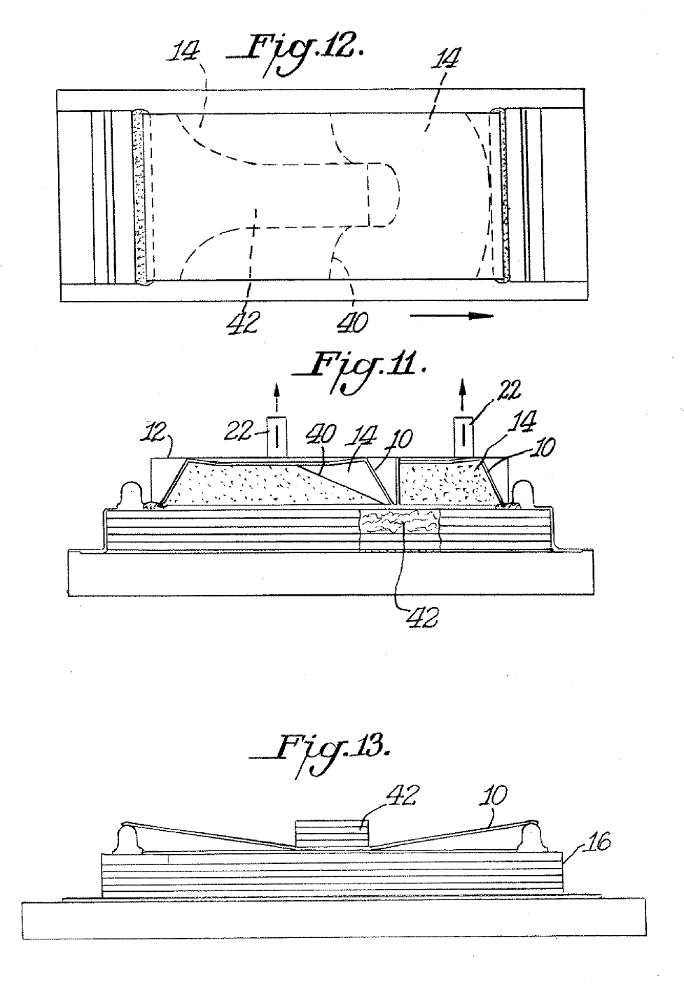

FIGS. 11-12 illustrate in side and top views a practice of the invention where the flexibility is increased by other techniques such as splitting the FFC into different small chambers 14 which are formed by the selective positioning of inserts 42 below vacuum bag 10. The small individual chambers are arranged sequentially in the direction of resin flow. In this practice there could be a sequential release of the vacuum from the chambers. This embodiment also illustrates how it is possible to fill the composite parts with inserts thereby increasing the flexibility of the FFC. The goal of this chamber integrated in the large FFC is to fill at first the area under one or a few inserts 42.

FIG. 13 shows yet another practice of the invention where one or more inserts 42 are placed on top of vacuum bag 10 before the shell 12 would be mounted on the unit. This would retard the stretching of vacuum bag 10 in the area of the inserts, but the vacuum bag 10 would otherwise freely stretch away from preform 16 when the shell is mounted and the vacuum is applied as previously described.

The present invention thus provides various techniques for improvement in VARTM such as by achieving reasonable fill times, having good surface quality with reduction of waste. In addition, the invention provides flexibility of the process.

What is claimed is:

1. A vacuum assisted resin transfer molding unit comprising a vacuum bag for being disposed over a preform, a layer of impermeable material placed over said vacuum bag in sealed relationship therewith to create a space between said layer and said vacuum bag, and at least one vacuum line communicating with said space to create a vacuum in said space for freely stretching and lifting said vacuum bag away from the preform to create a flow flooding chamber between said vacuum bag and the preform, said space comprising a flow improvement chamber forming said flow flooding chamber into an increased permeability channel whereby resin flow in said flow flooding chamber above the preform is enhanced and upon release of the vacuum in said flow improvement chamber the resulting increase in pressure may compress said bag whereby the resin is driven into the preform.

2. The unit of claim 1 wherein said layer is a shell made of a rigid material, and a resin injection line downstream from said flow flooding chamber.

3. The unit of claim 2 wherein said unit is free of a distribution media and peel ply above the preform.

4. The unit of claim 1 including a pressure regulator communicating with said vacuum line.

5. The unit of claim 1 wherein at least one insert is located in said flow flooding chamber.

6. The unit of claim 1 wherein said flow flooding chamber comprises a plurality of individual chambers.

7. The unit of claim 6 wherein said individual chambers are sequentially arranged in the direction of resin flow.

8. A method for improving vacuum assisted resin transfer molding comprising feeding a resin to a preform in a feed direction below a vacuum bag, mounting a rigid external shell on top of the vacuum bag, creating a vacuum in the space between the shell and the vacuum bag to form a flow improvement chamber in the space, and the vacuum in the flow improvement chamber freely stretching and lifting the vacuum bag to create a flow flooding chamber between the vacuum bag and the preform which comprises a flow channel of increased permeability for the resin flow during injection of the resin, and thereafter releasing the vacuum from the chamber to create a pressure which compresses the vacuum bag on the preform to drive the resin into the preform.

9. The method of claim 8 including locating at least one insert in the flow flooding chamber.

10. The method of claim 8 including forming the flow flooding chamber into a plurality of chambers located sequentially in the direction of flow of the resin.

11. The method of claim 8 wherein method is performed without the use of a distribution media and without the use of a peel ply above the preform.

12. The method of claim 8 including controlling the stretching and lifting of the vacuum bag through use of a pressure regulator.
